(19) United States
(12) Patent Application Publication
(10) Pub. No.: US 2007/0139202 A1
(43) Pub. Date: Jun. 21, 2007

(54) Radio frequency identification (RFID) solution to lost time spent on instrument inventory

(75) Inventor: Timothy B. Austin, Stony Brook, NM (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/312,511

(22) Filed: Dec. 21, 2005

(51) Int. Cl. A01J 25/13; G08B 13/14

(52) U.S. Cl. 340/572.8; 249/117

(57) ABSTRACT

A method for manufacturing an object having an encapsulated radio frequency identification (RFID) tag is provided. An RFID tag is mechanically or chemically affixed to a first portion of the object being manufactured. The first portion of the object, with the RFID tag affixed is placed in a cavity of a mold. The first portion is then over-molded with a first material such as high temperature thermoplastic or low temperature thermoset to generate a seamless object. A method for manufacturing an object having a partially encapsulated RFID tag is also provided. An RFID tag is laminated with a lamination material, such as high temperature thermoplastic. The laminated RFID tag is affixed to a mold. The laminated RFID tag is then over-molded with a first material to generate a seamless object. Methods for tracking medical instruments having encapsulated or partially encapsulated RFID tags are also provided.

### FIELD OF THE INVENTION

The present invention is related generally to radio frequency identification (RFID) tags and specifically to RFID tags encapsulated or partially encapsulated within objects using high and low temperature manufacturing methods and the use of those objects in the field of medicine.

### BACKGROUND OF THE INVENTION

The ability to quickly inventory instruments is critical in certain applications. For example, surgeons, nurses, and other medical personnel spend significant time delaying the end of a procedure in order to account for misplaced medical instruments. This delay increases costs to hospital and medical facilities (e.g., lost hours of operating theater teams) and increases risk to patients due to extended time under anesthesia. Current methods for generating a pre-procedure and post-procedure inventory of medical instruments are manual. For example, an individual makes a list of instruments assembled for use in the procedure. After the procedure, an individual checks instruments off against the list. This process is time consuming and prone to human errors.

Therefore, what is needed is an automated process that increases the speed of and reduces the errors in instrument verification applications.

In addition, the use of traditional methods of RFID tag attachment to medical instruments is not practical for a variety of reasons. For example, attaching an RFID tag to the surface of a medical instrument creates seams, depressions, and/or surfaces which facilitate the growth of bacteria or other organisms. Furthermore, many current RFID tag structures cannot withstand repeated sterilization processes.

Therefore, what is further needed is a seamless medical instrument having an encapsulated or partially encapsulated RFID tag.

### BRIEF SUMMARY OF THE INVENTION

The present invention is directed to the manufacture of an object having an encapsulated radio frequency identification (RFID) tag. In accordance with aspects of the invention, an RFID tag is affixed to a first portion of the object being manufactured. The first portion of the object, with the RFID tag affixed, is placed in a cavity of a mold. The first portion is then over-molded with a first material to generate a seamless object.

The present invention is also directed to the manufacture of an object having a partially encapsulated RFID tag. In accordance with aspects of the invention, an RFID tag is laminated with a suitable lamination material. The laminated RFID tag is then affixed to a mold. The laminated RFID tag is then over-molded with a first material to generate a seamless object.

The present invention is further directed to methods for tracking medical instruments having encapsulated or partially encapsulated RFID tags. In accordance with aspects of the invention, one or more instruments assembled for a medical procedure are scanned to generate a list of pre-procedure RFID tag identification numbers. The pre-procedure list of tag identification numbers is then stored. Upon completion of the procedure, one or more instruments are scanned to generate a list of post-procedure RFID tag identification numbers. The pre-procedure and post-procedure lists of tag identification numbers are compared to identify any missing instruments. If instruments are missing, the location of the medical procedure can be scanned to locate the identified missing instruments.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts an RFID tag encapsulated in a portion of a seamless object, according to an embodiment of the invention.

FIG. 2 depicts an RFID tag partially encapsulated in a portion of a seamless object, according to an embodiment of the invention

FIG. 3 depicts a flowchart of a method for tracking an encapsulated or partially encapsulated RFID tag in a medical instrument, according to an embodiment of the present invention.

FIG. 4 depicts a flowchart of a method for manufacturing a seamless object having an encapsulated RFID tag, according to an embodiment of the present invention.

FIGS. 5A-5F illustrate an exemplary seamless object having an encapsulated RFID tag during various stages of manufacture, according to an embodiment of the present invention.

FIG. 6 depicts a flowchart of a method for manufacturing a seamless object having a partially encapsulated RFID tag, according to an embodiment of the present invention.

FIGS. 7A-7D illustrate an exemplary seamless object having a partially encapsulated RFID tag during various stages of manufacture, according to an embodiment of the present invention.

FIG. 8 depicts a flowchart of a low temperature method for manufacturing a seamless object having an encapsulated RFID tag, according to an embodiment of the present invention.

FIGS. 9A-9F illustrate an exemplary seamless object having an encapsulated RFID tag during various stages of manufacture, according to an embodiment of the present invention.

FIG. 10 is a block diagram of an environment where one or more tag readers communicate with one or more tags, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1.0 Introduction

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond. Each tag can store a unique identification number. The tags respond to the reader transmitted read signals by providing their identification number so that they can be identified.

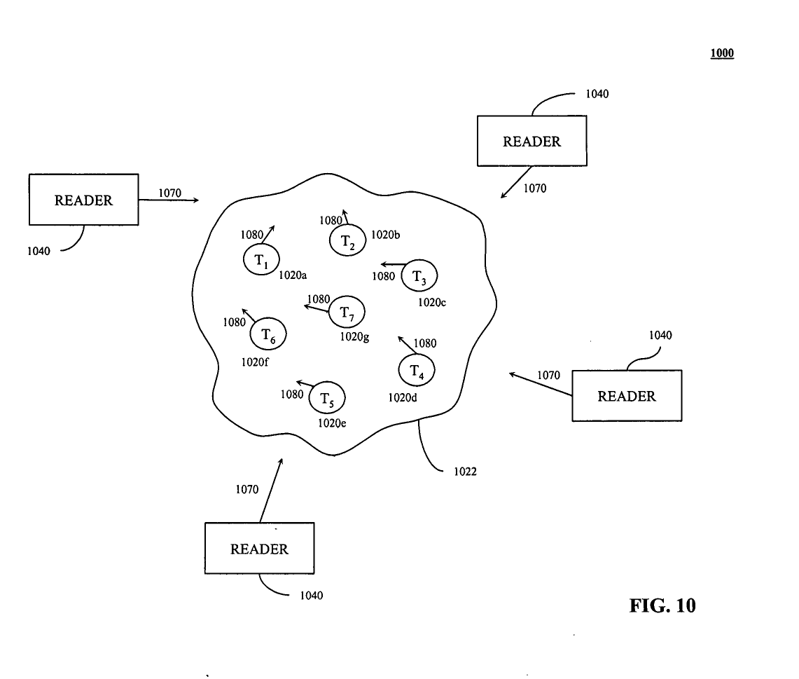

FIG. 10 illustrates an environment 1000 where one or more RFID tag readers 104 communicate with an exemplary population of RFID tags, according to the present invention. As shown in FIG. 10, the population of tags 1022 includes seven tags 1020a-1020g. According to embodiments of the present invention, a population of tags 1022 may include any number of tags 1020.

Exemplary environment 1000 also includes one or more readers 1040. These readers 1040 may operate independently or may be coupled together to form a reader network. A reader 1040 may be requested by an external application to address the population of tags 1022. Alternatively, the reader may have internal logic that initiates communication. When the reader is not communicating with the population of tags, the reader 1040 typically does not emit RF energy. This allows other readers to act upon the same population of tags, but from a different orientation, so as to achieve as complete of coverage with RF signals into the entire population of tags as possible. In addition, the same reader may act upon the same population of tags using a different frequency to increase tag coverage.

Signals 1070 and 1080 are exchanged between a reader 1040 and the tags 1020 according to one or more interrogation protocols. Signals 1070 and 1080 are wireless signals, such as radio frequency (RF) transmissions. Upon receiving a signal 1070, a tag 1020 may produce a responding signal 1080 by alternatively reflecting and absorbing portions of signal 1070 according to a time-based pattern or frequency. This technique for alternatively absorbing and reflecting signal 1070 is referred to herein as backscatter modulation. The present invention is also applicable to RFID tags that communicate in other ways.

### 2.0 Object Having an Encapsulated or Partially Encapsulated RFID Tag

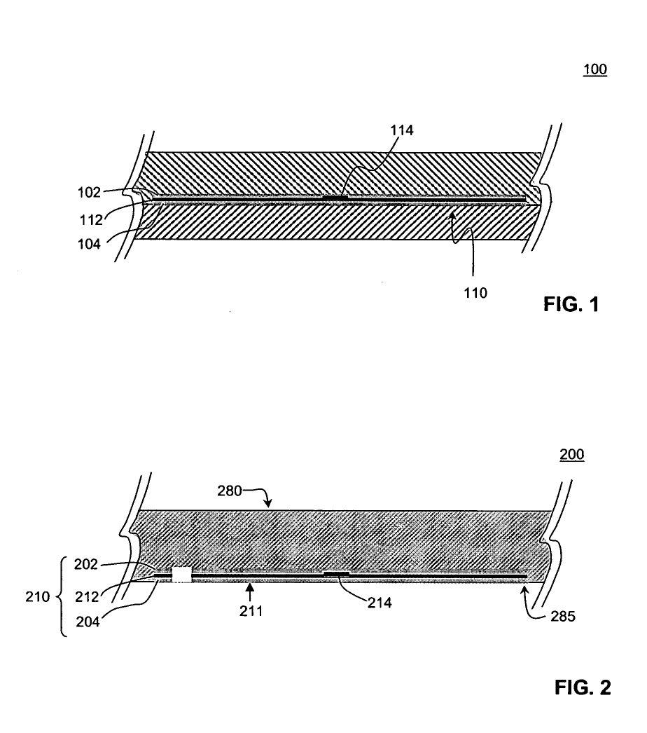

FIG. 1 depicts a partial view of an RFID tag encapsulated in a seamless object 100, according to an embodiment of the invention. Object 100 may be any type of instrument or product needing tracking. The object may be a medical instrument, such as an instrument used by surgical staff in an operating theater. Because of the method used to manufacture object 100 (described below), object 100 does not have any seams. A seam is a line or slight protrusion where two edges join. The absence of seams is critical for medical applications where seams, depressions, and/or other surfaces can collect bacteria or other unwanted organisms.

The object may be a product or component of a product having high monetary value. In an embodiment, because the tag is seamlessly embedded in the object, the tag cannot be removed without visibly damaging the object. This has added benefit of enhancing security by making theft more difficult. In a further embodiment, the object may be a product or component of a product having relatively low monetary value, but having high performance value. For example, an aircraft component may be relatively inexpensive but the proper performance of the component is critical to the operation of the aircraft. In these applications, a counterfeit product not operating up to specifications can have enormous monetary and social impacts.

As shown in FIG. 1, object 100 includes an encapsulated RFID tag 110. RFID tag 110 includes an RFID chip 114 and an antenna (not shown) coupled to a substrate 112. Tag 110 optionally includes an upper laminate layer 102 proximate to the upper surface of tag substrate 112 and a lower laminate layer 104 proximate to the lower surface of tag substrate 112.

RFID chip 114 includes, among other components, a memory for storing a tag identification number, referred to herein as “the tag ID.” In an embodiment, the stored tag ID is unalterable. The memory may also store other information (e.g., object specific data), as required by a particular application.

Because tag 110 is seamlessly embedded within object 100, the tag is preferably a passive tag. In general, a passive tag receives operating power from an incident interrogation signal. As would be appreciated by a person of skill in the art, an active tag (i.e., a tag having an internal power source) or a pass-active tag could be used with the present invention, based on the needs of a particular application.

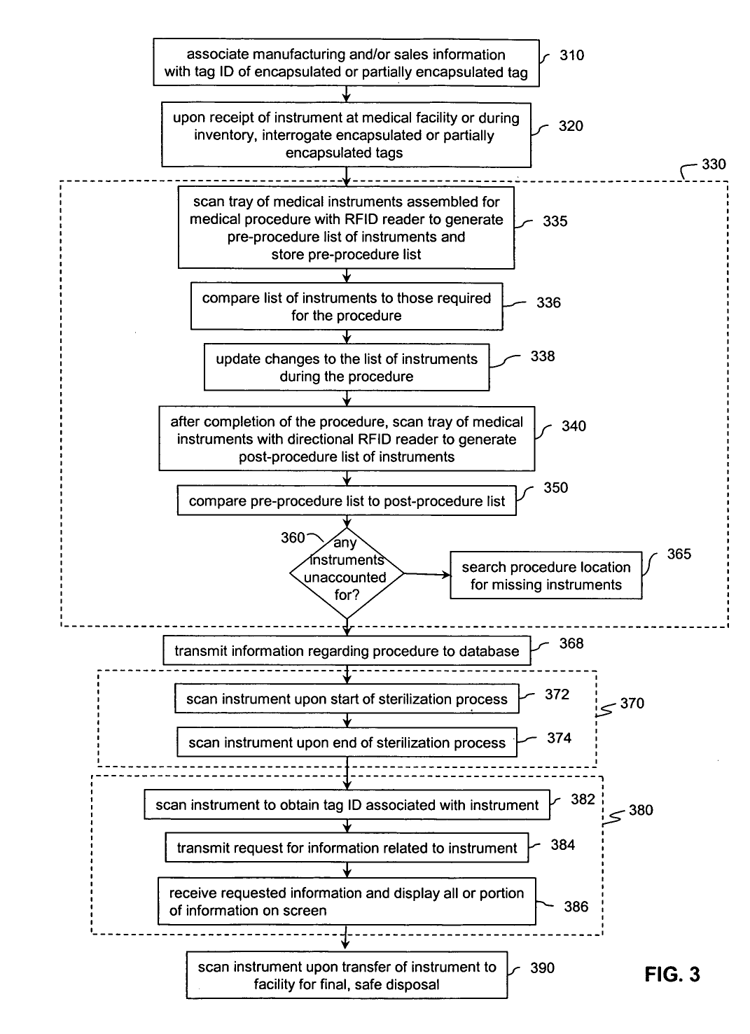

FIG. 2 depicts a partial view of a seamless object 200 having an RFID tag partially encapsulated therein, according to an embodiment of the invention. Because of the method used to manufacture object 200 (described below), object 200 does not have any seams. Object 200 includes an upper surface 280 and a lower surface 285. Object 200 includes an RFID tag 210 at least partially encapsulated in object 200. As can be seen in FIG. 2, a lower surface 211 of RFID tag 210 is a portion of the lower surface 285 of object 200. In object 200 depicted in FIG. 2, a surface of the RFID tag is exposed.

RFID tag 210 includes an RFID chip 214 and an antenna (not shown) coupled to a substrate 212. Tag 210 includes an upper laminate layer 202 proximate to the upper surface of tag substrate 212 and a lower laminate layer 204 proximate to the lower surface of tag substrate 212.

RFID chip 214 includes, among other components, a memory for storing the tag ID. In an embodiment, the stored tag ID is unalterable. The memory may also store other information (e.g., object specific data), as required by a specific application.

### 3.0 Method for Tracking Medical Instruments Having Encapsulated or Partially Encapsulated RFID Tags

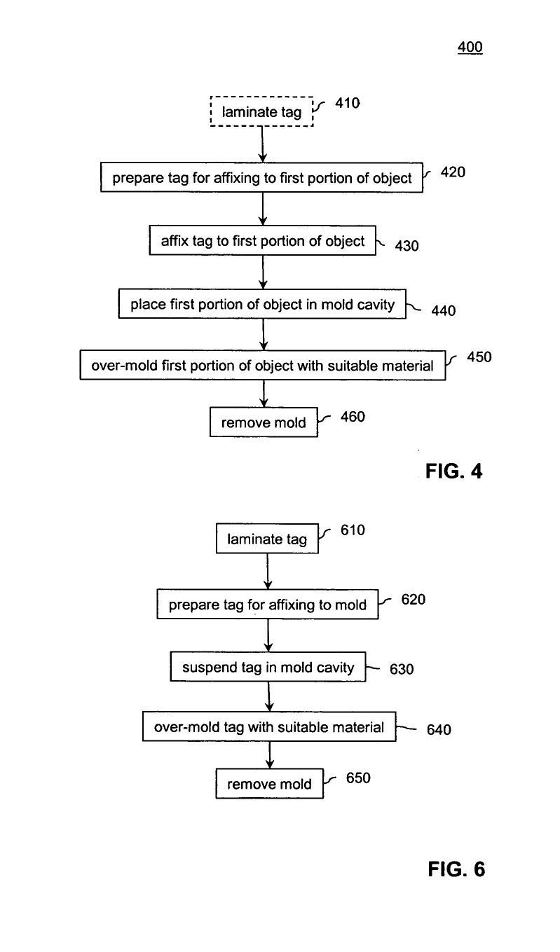

FIG. 3 depicts a flowchart 300 of a method for tracking an encapsulated or partially encapsulated RFID tag in a medical instrument, according to an embodiment of the present invention. Flowchart 300 will be described with continued reference to the example seamless object having an encapsulated or partially encapsulated RFID tag depicted in FIGS. 1 and 2. However, the invention is not limited to those embodiments. Note that some steps shown in flowchart 300 do not necessarily have to occur in the order shown.

In step 310, manufacturing and/or sales information is associated with the tag ID of an RFID tag encapsulated or partially encapsulated in an instrument. Step 310 is optional. When present, step 310 is typically performed by an instrument manufacturer and/or wholesale or retail distributor. For example, in step 310, a reader interrogates the encapsulated RFID tag to obtain the tag ID. Then, either manually or through another method (e.g., by scanning a bar code), details about the manufacturing and/or sales of the instrument (e.g., instrument type, serial number, sale date, parties to sale) are associated with the tag ID in a database. The database containing the tag IDs and associated information may be maintained by the manufacturer, wholesaler, and/or retailer of the instrument. Alternatively, the database may be maintained by a third party. For example, a national or regional medical association may maintain a database for tracking certain types of medical instruments for anti-counterfeiting purposes.

A medical facility may keep an inventory of all instruments owned or under the control of the medical facility. For example, the medical facility may log new instruments as they arrive to the facility. In addition, periodic inventories of the instruments in the facility may be performed. In step 320, a reader, operated by or for a medical facility (e.g., hospital) interrogates an RFID tag encapsulated or partially encapsulated in the instrument to obtain the tag ID. The reader then transmits the tag ID and optional associated information to a database maintained by or on-behalf of the medical facility.

The medical facility database includes a plurality of entries such, at least one per tag ID/instrument pair. Each entry includes information associated with the instrument such as serial number, manufacturer, date received by facility, sterilization information, and use information. In an embodiment, the medical facility may query a third party database to obtain additional history information or to verify the authenticity of the instrument. In addition, the medical facility may query the manufacturer to obtain information related to the manufacture of the instrument.

In step 330, one or more medical instruments having embedded RFID tags are tracked during a medical procedure (e.g., an operation, a check-up). Step 330 includes steps 335-368. Current methods for tracking instruments used in a medical procedure are primarily manual. In these methods, an individual makes a list or count of instruments assembled for use in the procedure. After the procedure, an individual checks instruments off against the list. This process is time consuming and prone to human errors. In addition, the procedure cannot be ended until all instruments are accounted for. Therefore, the length of the instrument verification process may extend the time period during which a patient is under anesthesia, increasing the risk to the patient. An automated process that increases the speed of and reduces the errors in instrument verification is highly desirable.

In step 335, a tray of medical instruments assembled for a procedure is scanned with an RFID reader. For example, the tray can be scanned by a directional RFID reader or a portal-type RFID reader located at the entrance of the procedure (e.g., door to the theater) or embedded in the instrument tray. As would be appreciated by a person of skill in the art, other types of RFID readers can be used to perform the scan operation. The scan operation reads the tag ID for each instrument located on the tray (or in the area covered by the directional interrogation signal) and generates a pre-procedure list of instruments. The reader stores the pre-procedure list of tag IDs present at the location (e.g., operating theater).

In step 336, the list is compared to a pre-existing list of instruments required for a specific procedure. Procedure specific trays (e.g., a knee tray or a hip tray) are meant to ensure that all the instruments required for the operating procedure are available beforehand. Automated checking of the tray contents prior to the procedure will reduce the chance of discovering, part way through a procedure, a required instrument was not included on the tray.

In addition, during the course of the procedure, the RFID tags can be read in real-time to track changes in the instrument count. These mid-procedure scans can be used to account for various situations, including the addition of instruments to the procedure location as and when the instruments are needed. In step 338, changes to the list of instruments are made based on mid-procedure scans.

In step 340, after the medical procedure is completed, the tray of medical instruments (and/or an area covered by the directional interrogation signal) is scanned with the directional RFID reader. The scan operation reads the tag ID for each instrument located on the tray and generates a post-procedure list of instruments.

In step 350, the RFID reader compares the pre-procedure list to the post-procedure list to determine if all pre-procedure instruments have been accounted for.

In step 360, a determination is made whether any pre-procedure instruments are unaccounted for. If one or more pre-procedure instruments are unaccounted for, operation proceeds to step 365. If all pre-procedure instruments are accounted for, operation proceeds to step 368.

In step 365, the medical procedure location (e.g., operating theater) is searched using the directional RFID reader to find the missing pre-procedure instruments. In an embodiment, the reader performs an interrogation for specific tag identification numbers identified as missing. In an alternate embodiment, the reader performs a general interrogation for any tags within its interrogation field. Operation returns to step 360.

In step 368, information regarding the procedure (e.g, tag IDs used, date/time of pre-procedure scan, date/time of post-procedure scan, result of scan) are transmitted to the facility database. This information is stored as use information in the database. Step 368 is optional.

Although some or all of the steps associated with the procedure instrument tracking application are described above as provided by an application program executing on the reader, a person of skill in the art will recognize that a reader could interact with an application executing on a remote server to perform some or all of the above steps.

After all the pre-procedure instruments have been accounted for, the instruments are sent for sterilization. Any method for sterilization can be used with instruments having seamlessly embedded RFID tags. For example, autoclaving (steam sterilization) or Ethylene DiOxide (EtO) sterilization can be used. Step 370 traces the movement of an instrument through the sterilization process. Step 370 may be performed any time an instrument with an embedded RFID tag requires sterilization. Step 370 includes steps 372 and 374.

In step 372, a reader scans an instrument upon the start of the sterilization process (e.g., entry to the sterilization vessel) to obtain the tag ID of the instrument. The tag ID is transmitted to the medical facility database, along with an optional indication of an action being taken (e.g., sterilization). In addition, information related to the sterilization process (e.g., time started, type of sterilization, etc.) can be transmitted to the database and/or associated with the tag ID in the database.

In step 374, a reader scans the instrument upon completion of the sterilization process (e.g., exit from the sterilization vessel). The tag ID associated with the instrument is transmitted to the medical facility database along with an optional indication of the action being taken (e.g., sterilization). In addition, information related to the sterilization process (e.g., time ended, type of sterilization, etc.) can be transmitted to the database and/or associated with the tag ID in the database.

In certain circumstances, an employee, agent, or person associated with a medical facility may require immediate access to the history of an instrument. For example, prior to use of an instrument, a physician may access the sterilization history of the instrument. In step 380, the history of a medical instrument is accessed. Step 380 includes steps 382-386.

In step 382, a reader scans a medical instrument to obtain the tag ID associated with the instrument.

In step 384, the reader transmits a request for information related to the tag ID/instrument. In an embodiment, the request for information may be for a specific type of information or a specific field.

In step 386, the database transmits the requested information to the reader which then displays all or a portion of the received information to the user. Based on the displayed information, an action may be performed on the instrument. For example, the instrument may be inspected for defects.

Tracking of the instruments, according to one or more of the above steps, continues until the final, safe disposal of the instrument. In step 390, the instrument is scanned upon transfer of the instrument from the medical facility to a facility for final, safe disposal. An instrument may be disposed of or recycled, if determined to be defective or at the end of its expected lifespan.

### 4.0 Methods for Manufacturing Objects Having an Encapsulated or Partially Encapsulated RFID Tag

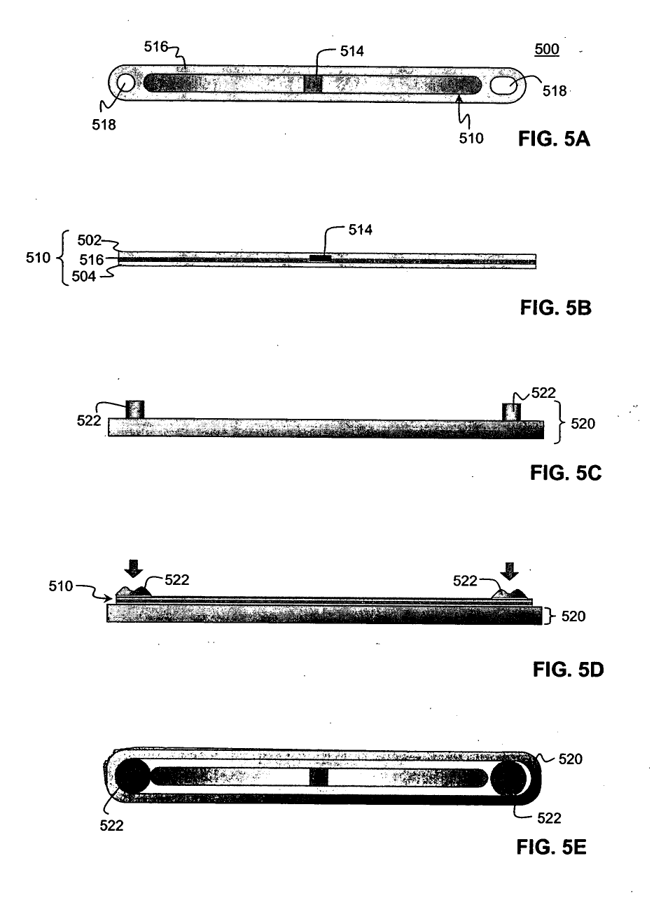

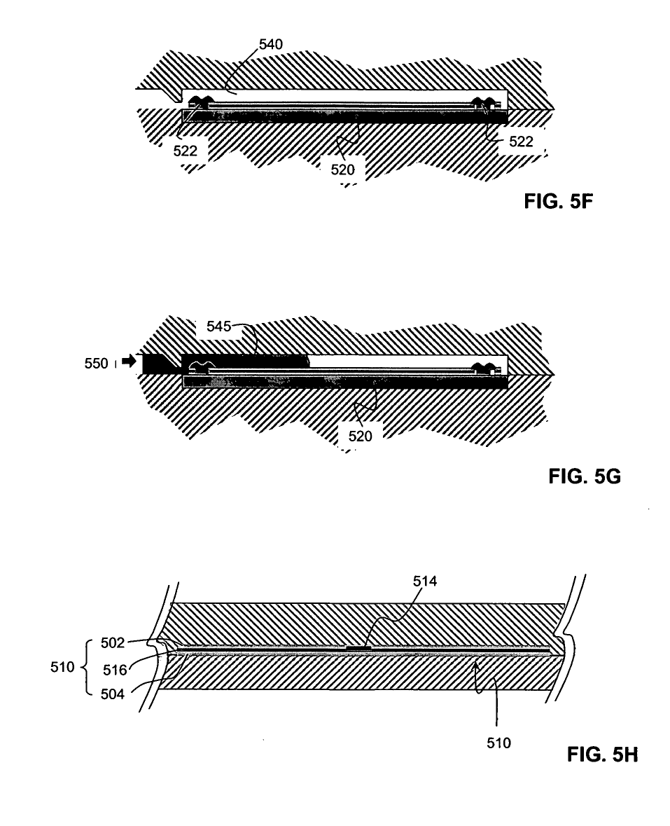

FIG. 4 depicts a flowchart 400 of a method for manufacturing a seamless object having an encapsulated RFID tag, according to an embodiment of the present invention. Note that some steps shown in flowchart 400 do not necessarily have to occur in the order shown. For illustrative purposes, the steps of FIG. 4 are described with respect to FIGS. 5A-5H. FIGS. 5A-5H show views of an object during various phases of manufacture.

In step 410, the tag is laminated between two layers to generate a laminated tag structure. Step 410 is optional. FIGS. 5A and 5B illustrate top and side views of a laminated tag structure 500. Laminated tag structure 500 includes a tag 510 having a substrate 516, an RFID chip 514, and an antenna. In addition, laminated tag structure 500 includes an upper laminate layer 502 coupled to the upper surface of tag 510 and a lower laminate layer 504 coupled to the lower surface of tag 510. In an embodiment, the laminate layers are made from a high temperature thermoplastic film. High temperature thermoplastics such as Polyetherimide (PEI) (e.g., GE Plastics Ultem 1000) maintain dimensional stability at high temperatures. This characteristic reduces the likelihood of the RFID chip becoming detached from the substrate and decreases the tag production cycle time by enabling higher cure temperatures. In addition, high temperature thermoplastic materials can withstand repeated sterilization, including autoclaving and EtO, and thus, are ideal for medical applications. As would be appreciated by persons of skill in the art, any suitable laminate material can be used to laminate the tag.

In step 420, the tag is prepared for affixing to the first portion of the object. A tag can be affixed to the first portion of the object mechanically or chemically, for example. In an exemplary mechanical method, one or more location holes are cut into the laminated tag structure. As can be seen in FIG. 5A, laminated tag structure 500 includes a plurality of location holes 518. In an exemplary chemical method, an adhesive (e.g., a high temperature adhesive) is applied to a surface of the laminated tag structure.

In step 430, the laminated tag structure is affixed to the first portion of the object. In the exemplary mechanical method depicted in FIGS. 5A-5E, laminated tag structure 500 is affixed to a first portion 520 of the object by aligning the one or more location holes 518 with the one or more locating pins 522 of the first portion. FIG. 5C depicts a side view of first portion 520. The number of locating pins 522 corresponds to the number of location holes 518 cut into the laminated tag structure. In an alternate embodiment, there are more location holes 518 cut into the laminated tag structure than locating pins. The locating pins are heat-staked down to retain the laminated tag structure on the first portion 520 of the object. FIG. 5D depicts a side-view and FIG. 5E depicts a top view of the resulting first portion with the locating pins heat-staked down. As can be seen in FIGS. 5D and 5E, the heat-staked down locating pins hold the laminated tag structure 510 securely to the first portion 520 of the object. As would be appreciated by persons of skill in the art, other mechanical methods can be used to affix the laminated tag structure to the first portion of the object.

In the exemplary chemical method, the surface of the laminated tag structure having the adhesive is coupled to a surface of the first portion of the object. As would be appreciated by persons of skill in the art, other chemical methods for affixing a tag structure to an object can be used with the present invention.

In step 440, the first portion 520 of the object is placed in a mold cavity. FIG. 5F depicts an exemplary mold cavity 540. As can be seen in FIG. 5F, mold cavity 540 defines an empty space for a second portion 545 (shown being formed in FIG. 5G) of the object to be formed. Although FIG. 5F depicts mold cavity as having a rectangular cross-section, a person of skill in the art will recognize that any shape can be used for the mold cavity. The size, shape, and dimensions of the mold cavity are determined based upon the requirements of the object being constructed.

In step 450, the first portion of the object is over-molded with a suitable material to create the second portion of the object. For example, as shown in FIG. 5G, an over-mold material is being inserted into cavity 540 through an input port 550. The over-mold material forms a second portion 545 of the object which bonds with the first portion 520 to create a seamless object. In an embodiment, the first portion 520 of the object is over-molded with a high temperature thermoplastic. Over-molding a thermoplastic film, such as used to laminate the RFID tag in step 410, is a proven technology. FIG. 5G depicts the over-molding process.

In step 460, the mold is removed. FIG. 5H illustrates a partial view of an exemplary object having an encapsulated RFID tag, manufactured according to the method of flowchart 300. As shown in FIG. 5F, the RFID tag 510 is completely encapsulated within the object.

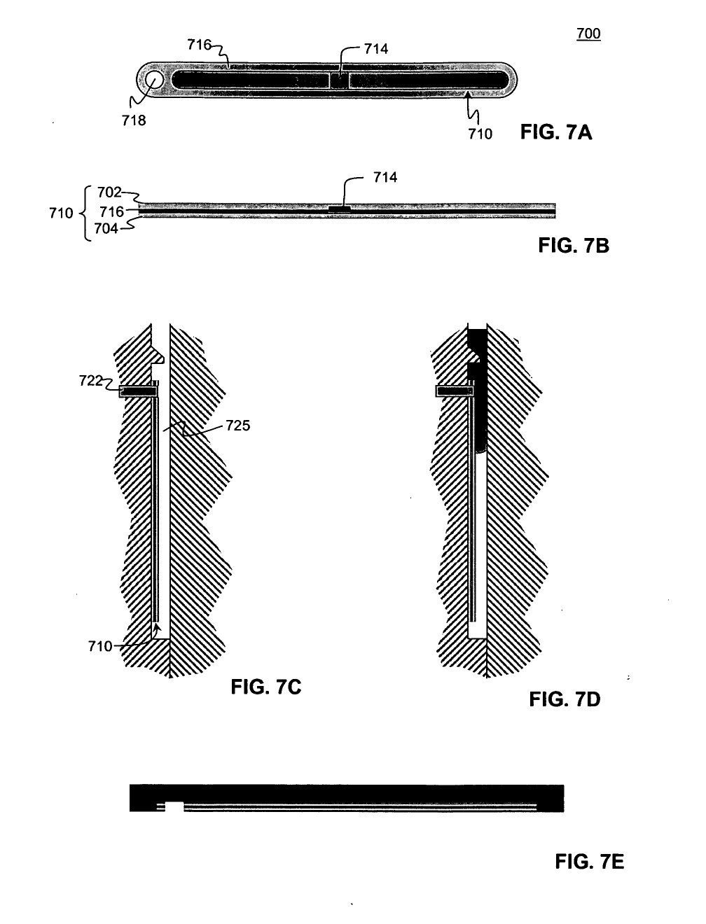

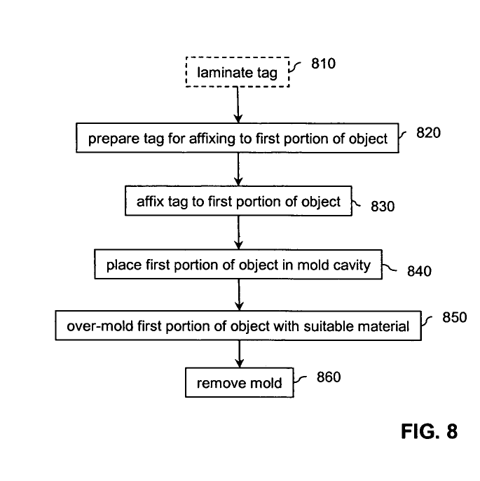

FIG. 6 depicts a flowchart 600 of a method for manufacturing a seamless object having a partially encapsulated RFID tag, according to an embodiment of the present invention. The method of FIG. 6 uses a single molding process. Note that some steps shown in flowchart 600 do not necessarily have to occur in the order shown. For illustrative purposes, the steps of FIG. 6 are described with respect to FIGS. 7A-7E. FIGS. 7A-7E show views of an object during various phases of manufacture.

In step 610, the tag is laminated between two layers to generate a laminated tag structure. FIG. 7A illustrates a top view and FIG. 7B illustrates a side view of laminated tag structure 700. Laminated tag structure 700 includes a tag 710 having a substrate 716, an RFID chip 714, and an antenna. In addition, tag structure 700 includes an upper laminate layer 702 coupled to the upper surface of tag 710 and a lower laminate layer 704 coupled to the lower surface of tag 710. In an embodiment, the laminate layers are made from a high temperature thermoplastic film. As would be appreciated by persons of skill in the art, any suitable material can be used to laminate the tag.

In step 620, the tag is prepared for affixing to a mold. In an embodiment, a tag is affixed to the mold mechanically. In an exemplary mechanical method, one or more suspension holes are cut in the laminated tag structure. FIG. 7A illustrates a laminated tag structure 710 having one suspension hole 718. In an alternate embodiment, a tag is affixed to the mold using a static charge. As would be appreciated by persons of skill in the art, other techniques for affixing the laminated tag to the mold can be used.

In step 630, the laminated RFID tag is suspended in a mold cavity. FIG. 7C illustrates an exemplary method for suspending a laminated tag structure 700. In FIG. 7C, laminated tag structure 700 is hung by hole 718 from a protrusion 720 in mold cavity 725.

In step 640, the laminated tag structure 710 is over-molded with a suitable material to create the object. In an embodiment, the laminated tag structure 710 is over-molded with a high temperature thermoplastic. Over-molding a thermoplastic film, such as used to laminate the RFID tag in step 610, is a proven technology often referred to as in-mold decorating (IMD). FIG. 7D depicts the over-molding step. For example, tag structure 710 can be over-molded in a similar fashion as described above for step 450 of FIG. 4.

In step 650, the mold is removed. FIG. 7D illustrates an exemplary object having a partially encapsulated RFID tag created according to the method of flowchart 600. As shown in FIG. 7D, a surface of laminated tag structure 710 is a portion of a surface of the object. Thus, in the method of 600, the laminated tag structure is not completely encapsulated within the object.

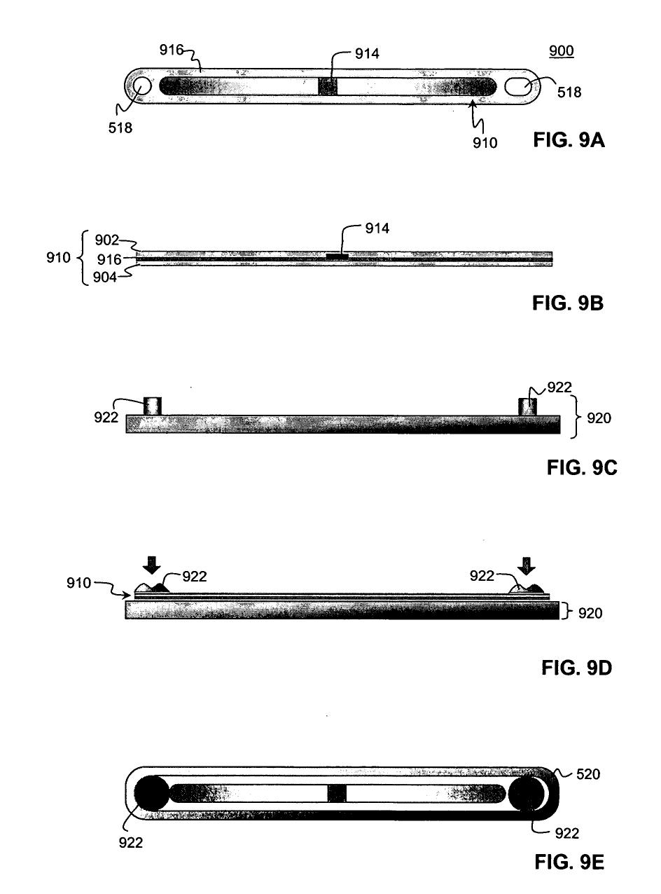

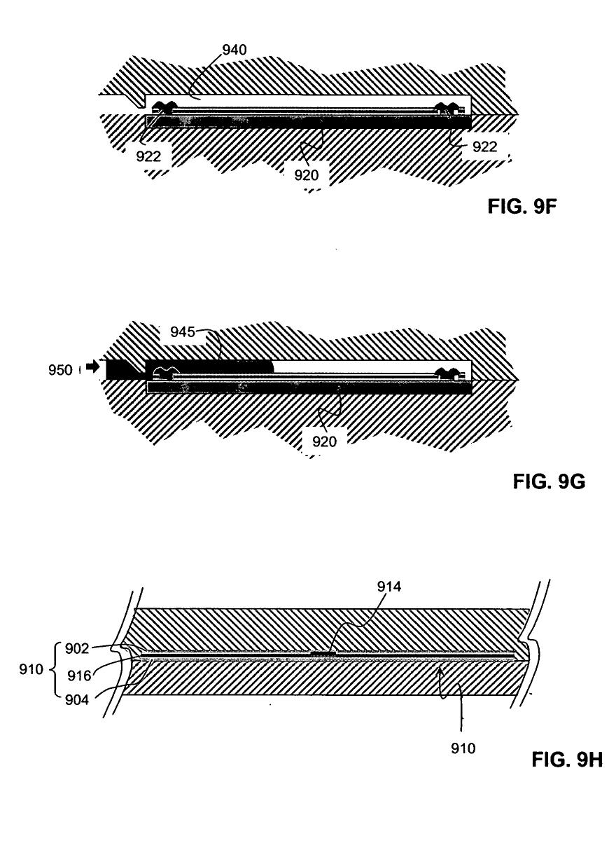

FIG. 8 depicts a flowchart 800 of a low temperature method for manufacturing a seamless object having an encapsulated RFID tag, according to an embodiment of the present invention. For illustrative purposes, the steps of FIG. 8 are described with respect to FIGS. 9A-9H. FIGS. 9A-9H show views of an object during various phases of manufacture.

In step 810, the tag is laminated between two layers to generate a laminated tag structure. Step 810 is optional. FIGS. 9A and 9B illustrate top and side views of a laminated tag structure 900. Laminated tag structure 900 includes a tag 910 having a substrate 916, an RFID chip 914, and an antenna (not shown). In addition, tag structure 900 includes an upper laminate layer 902 coupled to the upper surface of tag 910 and a lower laminate layer 904 coupled to the lower surface of tag 910. In an embodiment, the laminate layers are made from a low temperature thermoplastic film. In an alternate embodiment, the lamination layers are made from a thermoset. As would be appreciated by persons of skill in the art, other suitable laminate materials can be used to laminate the tag.

In step 820, the tag is prepared for affixing to the first portion of the object. A tag can be affixed to the first portion of the object mechanically or chemically, for example. In an exemplary mechanical method, one or more location holes are cut into the laminated tag structure. As can be seen in FIG. 9A, laminated tag structure 900 includes a plurality of location holes 918. In an exemplary chemical method, an adhesive (e.g., a low temperature adhesive) is applied to a surface of the laminated tag structure.

In step 830, the laminated tag structure is affixed to the first portion of the object. In the exemplary mechanical method depicted in FIGS. 9A-9E, laminated tag structure 800 is affixed to a first portion of the object by aligning the one or more location holes 818 with the one or more locating pins 922 of the first portion. FIG. 9C depicts a side view of first portion 920. The number of locating pins 922 corresponds to the number of location holes 918 cut into the laminated tag structure. In an alternate embodiment, there are more location holes 918 cut into the laminated tag structure than locating pins. The locating pins are heat-staked down to retain the laminated tag structure on the first portion 940 of the object. FIG. 9D depicts a side-view and FIG. 9E depicts a top view of the resulting first portion with the locating pins heat-staked down. As can be seen in FIGS. 9D and 9E, the heat-staked down locating pins hold the laminated tag structure 910 securely to the first portion 920 of the object. As would be appreciated by persons of skill in the art, other mechanical methods can be used to affix the laminated tag structure to the first portion of the object.

In the exemplary chemical method, the surface of the laminated tag structure having the adhesive is coupled to a surface of the first portion of the object. As would be appreciated by persons of skill in the art, other chemical methods for affixing a tag structure to an object can be used with the present invention.

In step 840, the first portion 920 of the object is placed in a mold cavity. FIG. 9F depicts an exemplary mold cavity 940. As can be seen in FIG. 9F, mold cavity 940 defines an empty space for a second portion 945 (shown being formed in FIG. 9G) of the object to be formed. Although FIG. 9F depicts mold cavity as having a rectangular cross-section, a person of skill in the art will recognize that any shape can be used for the mold cavity. The size, shape, and dimensions of the mold cavity are determined based upon the object being constructed.

In step 850, the first portion 940 of the object is over-molded with a suitable material to create the second portion of the object. For example, as shown in FIG. 9G, an over-mold material is being inserted into cavity 940 through an input port 950. The over-mold material forms a second portion 945 of the object which bonds with the first portion 940 to create a seamless object. In an embodiment, the first portion 940 of the object is over-molded with a thermoset material compatible with the lamination thermoset. Thermosets such as Liquid Injection Moldable (LIM) silicone rubber (e.g., Wacker Elastosil LR 3070-60) provide a soft-touch, colorable, over-mold surface that can be sterilized. In comparison to thermoplastic over-molding, thermosets provide a relatively low-temperature, low-pressure assembly process, enabling lower temperature materials and less rugged RFID tag structures to be used. As a result, lower cost materials can be used for both the tag and the hard plastic substrate.

In an alternate embodiment, in step 950, the second portion 945 of the object is created using compression molding.

In step 960, the mold is removed. FIG. 9H illustrates a partial view of an exemplary object having an encapsulated RFID tag, manufactured according to the method of flowchart 800. As shown in FIG. 9F, the RFID tag 910 is completely encapsulated within the object.

### 5.0 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for manufacturing an object having an encapsulated radio frequency identification (RFID) tag, the method comprising:
(a) affixing the RFID tag to a first portion of the object;
(b) placing the first portion of the object into a cavity of a mold; and
(c) over-molding the first portion of the object with a first material to generate a seamless object.

2. The method of claim 1, further comprising, prior to step (a):
laminating the RFID tag.

3. The method of claim 2, wherein the laminating step comprises:
laminating the RFID tag with a high temperature thermoplastic.

4. The method of claim 1, wherein step (a) further comprises:
(i) aligning at least one location hole in the RFID tag with a corresponding location pin coupled to the first portion of the object; and
(ii) heat stacking down the location pin to affix the RFID tag to the first portion of the object.

5. The method of claim 1, wherein step (a) further comprises:
(i) applying an adhesive to a first side of the RFID tag; and
(ii) coupling the first side of the RFID tag to a surface of the first portion of the object.

6. The method of claim 1, wherein step (c) comprises:
over-molding the first portion of the object with a high temperature thermoplastic.

7. The method of claim 2, wherein the laminating step comprises:
laminating the RFID tag with a low temperature thermoplastic.

8. The method of claim 2, wherein the laminating step comprises:
laminating the RFID tag with a thermoset.

9. The method of claim 2, wherein step (c) comprises:
over-molding the first portion of the object with a low temperature thermoset.

10. A method for manufacturing an object having a partially encapsulated radio frequency identification (RFID) tag, the method comprising:
(a) laminating the RFID tag;
(b) affixing the laminated RFID tag to a mold; and
(c) over-molding the laminated RFID tag with a first material to generate a seamless object.

11. The method of claim 10, wherein step (a) comprises:
laminating the RFID tag with a high temperature thermoplastic.

12. The method of claim 10, wherein step (b) further comprises:
(i) aligning at least one suspension hole in the RFID tag with at least one protrusion in the mold; and
(iii) suspending the RFID tag from the at least one protrusion, wherein a substantially planar surface of the RFID tag is proximate to a substantially planar interior surface of the mold.

13. The method of claim 10, wherein step (b) further comprises:
affixing the laminated RFID tag to a surface of the mold using a static charge.

14. The method of claim 10, wherein step (c) comprises:
over-molding the RFID tag with a high temperature thermoplastic.

15. A method for tracking instruments used during a medical procedure, wherein each instrument includes a radio frequency identification (RFID) tag and each RFID tag stores an identification number, the method comprising:
(a) scanning at least one instrument assembled for a medical procedure to generate a list of pre-procedure RFID tag identification numbers;
(b) storing the pre-procedure list of tag identification numbers;
(c) scanning at least one instrument after completion of the medical procedure to generate a list of post-procedure RFID tag identification numbers; and
(d) comparing the pre-procedure list of tag identification numbers with the post-procedure list of tag identification numbers to identify missing instruments.

16. The method of claim 15, further comprising:
after step (a), comparing the pre-procedure list of tag identification numbers to a list of instruments required for the medical procedure.

17. The method of claim 15, further comprising:
(e) scanning a location of the medical procedure to locate at least one instrument identified as missing in step (d).

18. The method of claim 17, wherein step (e) comprises:
performing an interrogation for the tag identification number associated with the at least one missing instrument.

19. The method of claim 15, further comprising:
(e) transmitting information associated with the procedure to a database.

20. The method of claim 15, further comprising:
(e) interrogating the RFID tag associated with the at least one instrument upon initiation of a sterilization process; and
(f) interrogating the RFID tag associated with the at least one instrument at the successful completion of the sterilization process.

21. The method of claim 20, further comprising:
(g) transmitting information associated with the sterilization process for the at least one instrument to a database.

22. A method for tracking and tracing a medical instrument through a life-cycle of the medical instrument, wherein the medical instrument includes a radio frequency identification (RFID) tag storing an identification number, the method comprising:
(a) scanning the RFID tag of the medical instrument when the instrument enters a medical facility;
(b) retrieving information related to the RFID tag from a database;
(c) comparing the retrieved information with information obtained from the scan of the RFID tag to verify the authenticity of the instrument; and
(d) transmitting information associated with the scan to the database.

23. The method of claim 22, further comprising:
(e) scanning the RFID tag of the medical instrument upon transfer of the medical instrument to a facility for final, safe disposal; and
(f) transmitting information associated with the transfer scan to the database.

24. The method of claim 22, further comprising:
(e) periodically scanning the RFID tag of the medical instrument within the medical facility; and
(f) transmitting information associated with the periodic scans to the database,
wherein the database maintains information associated with the medical instrument throughout the life of the instrument at the medical facility.

25. The method of claim 22, further comprising:
prior to step (a),
encoding the RFID tag with the identification number during manufacture of the medical instrument; and
transmitting information associated with the manufacture of the RFID tag to the database.
